(19) United States
(12) Patent Application Publication
(10) Pub. No.: US 2019/0197483 A1
(43) Pub. Date: Jun. 27, 2019

(54) LARGE-SCALE AGGREGATION AND VERIFICATION OF LOCATION DATA

(71) Applicant: Microsoft Technology Licensing, LLC, Redmond, WA (US)

(72) Inventors: Dezhen Li, San Francisco, CA (US); Kedar U. Kulkarni, Berkeley, CA (US); Caleb T. Johnson, Santa Clara, CA (US); Jean-Baptiste Chery, Walnut Creek, CA (US)

(73) Assignee: Microsoft Technology Licensing, LLC, Redmond, WA (US)

(21) Appl. No.: 15/884,054

(22) Filed: Jan. 30, 2018

Related U.S. Application Data
(60) Provisional application No. 62/610,071, filed on Dec. 22, 2017.

(51) Int. Cl. G06Q 10/10; G06F 17/30; G06F 7/14; G06Q 50/00

(52) U.S. Cl. CPC G06Q 10/1053; G06F 17/30604; G06Q 50/01; G06F 17/30371; G06F 7/14

(57) ABSTRACT

The disclosed embodiments provide a system for processing data. During operation, the system obtains a set of addresses for a set of entities. Next, for each address in the set of addresses, the system combines a set of verification rules and user input to generate a confidence in the address for a corresponding entity. The system then performs one or more steps for confirming the address according to the confidence in the address. Upon completing the one or more steps for confirming the address, the system stores the address for use with the corresponding entity.

### RELATED APPLICATION

This application claims priority under 35 U.S.C. § 119 to U.S. Provisional Application No. 62/610,071, entitled “Large-Scale Aggregation and Verification of Location Data,” by Dezhen Li, Kedar U. Kulkarni, Caleb T. Johnson and Jean-Baptiste Chery, filed 22 Dec. 2017 (Atty. Docket No.: LI-902198-US-PSP), the contents of which are herein incorporated by reference in their entirety.

### BACKGROUND

### Field

The disclosed embodiments relate to data verification. More specifically, the disclosed embodiments relate to techniques for performing large-scale aggregation and verification of location data.

### RELATED ART

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of verifying a set of addresses for a set of entities in accordance with the disclosed embodiments.

FIG. 4 shows a flowchart illustrating a process of verifying and confirming an address for an entity in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

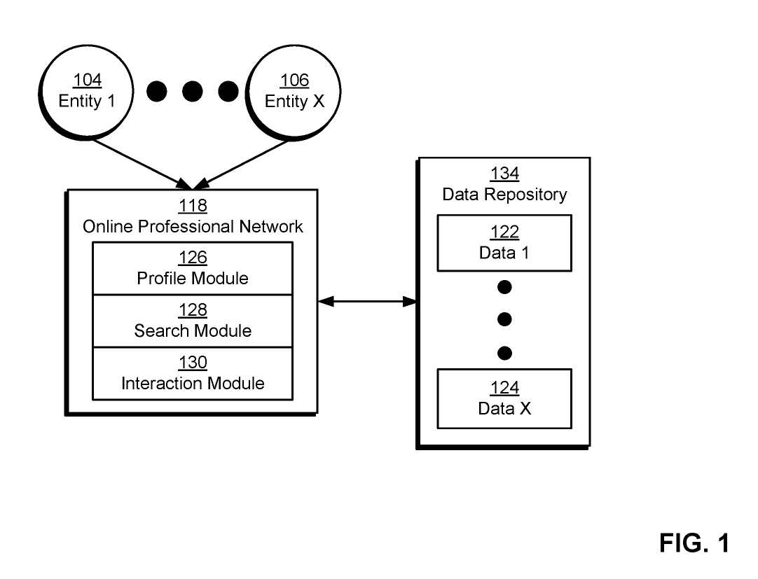

The disclosed embodiments provide a method, apparatus, and system for performing large-scale aggregation and verification of location data. As shown in FIG. 1, the location data may be associated with and/or used by members of a social network or other community, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, data in data repository 134 may be used to generate recommendations and/or other insights related to listings of jobs or opportunities within online professional network 118. For example, one or more components of the online professional network may track searches, clicks, views, text input, conversions, and/or other feedback during the entities' interaction with a job search tool in the online professional network. The feedback may be stored in data repository 134 and used as training data for one or more statistical models, and the output of the statistical model(s) may be used to display and/or otherwise recommend a number of job listings to current or potential job seekers in the online professional network.

To improve the quality or relevance of the recommendations and/or improve the user experience with searches, applications, inquiries, and/or placements of jobs or opportunities, online professional network 118 may use addresses and/or other location data associated with the corresponding schools, companies, and/or entities listing the jobs or opportunities to provide additional functionality and/or insights related to the locations of the entities. For example, online professional network 118 may allow job seekers to view job listings on a map, estimate commute times to the jobs using various modes of transportation (e.g., walking, cycling, public transit, driving, etc.), and/or search for and/or filter jobs by distance or commute time. In another example, online professional network 118 may use commute time as a factor in selecting or ordering job recommendations for job seekers.

On the other hand, online professional network 118 may lack comprehensive addresses and location data for the entities. For example, representatives of companies and/or other entities may omit exact addresses or location data from job listings, events, and/or other types of posts in online professional network 118. In another example, profiles for the companies and/or other entities may be created with online professional network 118 without requiring the entities to specify their exact addresses or physical locations. In a third example, address or location information for a user or company may become outdated after the user or company relocates to a new address or location.

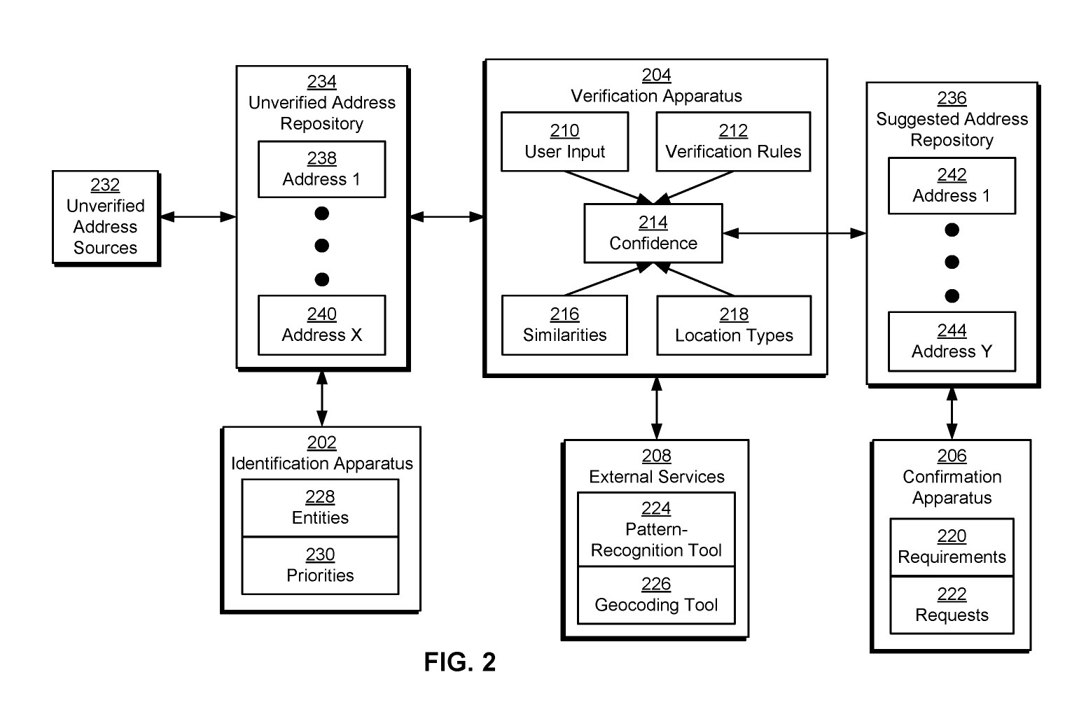

In one or more embodiments, online professional network 118 includes functionality to aggregate and verify addresses and/or other location data for companies, schools, organizations, and/or other entities with physical locations in online professional network 118. As shown in FIG. 2, an identification apparatus 202 identifies a set of entities 228 for which address and/or other location data is to be verified. For example, identification apparatus 202 may identify companies, schools, organizations, businesses, people, and/or other entities 228 with physical addresses and/or locations that are missing or require verification. In another example, identification apparatus 202 may identify entities 228 as company-city pairs that include a company (or other organization) and a city in which the company is located. Thus, multiple locations of a single company (e.g., a larger and/or multinational company) may be differentiated by one another using the company-city pairs.

Identification apparatus 202 optionally groups or filters entities 228 based on priorities 230 associated with entities 228. Priorities 230 may reflect the importance, reputation, and/or popularity of the corresponding entities 228. For example, a higher priority may be assigned to a subset of entities 228 that appear more frequently in search results or search terms, have more clicks or views than other entities 228, and/or have better reputations than the other entities 228.

After entities 228 are identified, a number of addresses (e.g., address 1 238, address x 240) for entities 228 is obtained from a set of unverified address sources 232. Unverified address sources 232 may include, but are not limited to, public records, crowdsourcing platforms, customer relationship management (CRM) platforms, websites, and/or users associated with entities 228 (e.g., employees of companies represented by entities 228, users that have “checked in” at the entities, etc.). For example, a crowdsourcing platform may be used to obtain a pre-specified and/or maximum number of crowdsourced addresses for each entity. In another example, the addresses may be derived from location information (e.g., coordinates, Internet Protocol (IP) addresses, etc.). In a third example, members of an online professional network may be voluntarily prompted for address information for their employers. By configuring privacy controls or settings as they desire, members of a social network, an online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings, and is in compliance with applicable privacy laws of the jurisdictions in which the members or users reside.

Addresses from unverified address sources 232 are aggregated into an unverified address repository 234 for subsequent retrieval and use. For example, the addresses may be stored with names and/or identifiers for the corresponding entities 228 (e.g., users, organizations, schools, companies, company-city pairs, etc.) in a database, filesystem, data warehouse, collection of files, cloud storage, and/or another type of data store.

The addresses may also be cleaned prior to being stored in unverified address repository 234. For example, excess whitespace (e.g., two or more spaces in a row, comma-space combinations, whitespace at the end of an address, etc.) may be removed from the addresses. In another example, each address may be standardized to conform to addressing requirements for a given location (e.g., country, region, etc.) and/or verified to be real physical addresses.

Next, a verification apparatus 204 combines user input 210 with a set of verification rules 212 to generate a confidence 214 in each address from unverified address repository 234. User input 210 may include addresses from unverified address sources 232. For example, user input 210 related to one or more addresses for a given entity may include crowdsourced addresses provided by members of an online community, addresses derived from location information provided by electronic devices of users, and/or addresses provided by unverified users associated with the entity. Alternatively, user input 210 may include an address for the entity that is provided by a verified representative of the entity, such as an administrator and/or office manager for a company.

Verification rules 212 include thresholds and/or other parameters for determining confidence 214 in a given address based on user input 210 for the address. For example, verification rules 212 may include thresholds for setting a level of confidence 214 in the address to high, medium, or low. A high confidence 214 may have a threshold for unanimous consensus in all crowdsourced or unverified addresses for an entity (i.e., identical crowdsourced addresses for the entity) and/or a minimum number of crowdsourced addresses for the entity (e.g., at least five respondents for the same crowdsourced address). A high confidence 214 may also, or instead, be identified when a verified representative of the entity provides an address for the entity (e.g., in a job listing or company page for the entity). A medium confidence 214 may have a threshold for a minimum consensus in crowdsourced addresses for the entity (e.g., at least 3 identical addresses out of 5 crowdsourced addresses, at least half of all crowdsourced addresses, etc.). If a set of addresses for the entity fails to meet the thresholds for either high confidence 214 or medium confidence 214, each of the addresses may be assigned a low confidence 214.

Verification apparatus 204 additionally uses one or more external services 208 to adjust confidence 214 and/or the associated addresses based on similarities 216 among the addresses and/or location types 218 of the addresses. For example, verification apparatus 204 may use a pattern-recognition tool 224 to calculate similarities 216 among strings representing addresses for an entity. If two or more strings have a similarity that exceeds a threshold, verification apparatus 204 may merge the strings into a common address and update one or more measures of consensus for the address (e.g., consensus count, consensus percentage, etc.). If the measure(s) of consensus subsequently exceed a threshold in verification rules 212, verification apparatus 204 may increase confidence 214 in the address accordingly.

In another example, verification apparatus 204 may use a geocoding tool 226 to perform validation of each address with a medium or high confidence 214. In the validation, verification apparatus 204 may obtain a location type as a street address, monument, mountain, body of water, and/or other geographic or navigational feature. Verification apparatus 204 may validate the address when the address can be geocoded and has a location type that represents a legitimate place of business or operation (e.g., a building and/or street address).

Verification apparatus 204 may further perform alternating rounds of adjustments and/or validation of addresses using pattern-recognition tool 224, geocoding tool 206, and/or other external services 208. For example, verification apparatus 204 may first use pattern-recognition tool 224 to merge similar addresses and update the corresponding levels of consensus and/or confidence 214 for each merged address. Next, for all addresses associated with medium or high confidence 214, verification apparatus 204 may use geocoding tool 206 to validate the existence and/or location types 218 of the addresses. Verification apparatus 204 may then use pattern-recognition tool 224 to merge all geocoded addresses with valid location types 218 and update confidence 214 accordingly.

After confidence 214 is assigned and/or updated based on user input 210, verification rules 212, similarities 216, and/or location types 218, verification apparatus 204 stores all medium or high confidence 214 addresses (e.g., address 1 242, address y 244) in a suggested address repository 236. For example, verification apparatus 204 may store each address with the corresponding level of confidence 214, a name of the corresponding entity (e.g., a company and/or city name), an identifier for the entity, and/or other relevant data in a database, filesystem, data warehouse, collection of files, cloud storage, and/or another type of data store.

A confirmation apparatus 206 then determines a set of requirements 220 for confirming medium and high confidence 214 addresses in suggested address repository 236 and performs one or more steps for confirming the addresses according to requirements 220. In particular, confirmation apparatus 206 transmits requests 222 to confirm the addresses to administrators, office managers, and/or other official representatives of the corresponding entities. If a representative does not respond to a request to confirm an address that is assigned a high confidence 214 within a pre-specified period (e.g., one week, two weeks, one month, etc.), confirmation apparatus 206 automatically confirms the address. Confirmation apparatus 206 also confirms the address upon receiving the requested confirmation from the representative within the pre-specified period.

On the other hand, confirmation apparatus 206 may require confirmation from the representative for an address that is assigned a medium confidence 214. If the entity lacks a known representative, confirmation apparatus 206 may automatically confirm any high-confidence or medium-confidence address for the entity.

After an address is confirmed, the address may be outputted and/or used to improve location-based services associated with the corresponding entity. For example, a confirmed address may be included in one or more job listings for the entity, a company listing for the entity, and/or other information related to the entity. In another example, the confirmed address may be used to estimate a commute time for a job candidate to the entity based on the job candidate's location or address, a specified method of transportation (e.g., walking, cycling, driving, public transit, etc.), and/or a time of day of the commute. In a third example, the job candidate may filter the job listings by commute time. In a fourth example, job recommendations for the job candidate may be generated and/or ordered based on commute time, distance between the job candidate and entity, and/or other location-based criteria.

Conversely, verification apparatus 204 may retain addresses with low confidence 214 in unverified address repository 234 and obtain additional user input 210 to validate the addresses. For example, verification apparatus 204 may initiate additional rounds of crowdsourcing to determine if any low-confidence addresses for an entity have higher consensus than the initial round of crowdsourcing of the addresses. In another example, verification apparatus 204 may initiate custom collection of the address for the entity by temporary workers that use phone calls, web searches, and/or other methods to obtain the address. Any addresses that are obtained and/or boosted from additional crowdsourcing and/or custom collection may then be verified using the corresponding user input 210, verification rules 212, similarities 216, and/or location types 218, as discussed above. In a third example, verification apparatus 204 and/or another component of the system may generate notifications, messages, and/or other communications to representatives of the corresponding entities and/or other users associated with the entities (e.g., employees at a company) to obtain additional user input 210 for determining the validity of the corresponding addresses. After an address is associated with low confidence 214 and/or remains in unverified address repository 214 for a given period (e.g., one week, two weeks, one month, etc.), the address may be removed from unverified address repository 214 and/or consideration as a potentially valid address for the corresponding entity.

By assigning different levels of confidence 214 to addresses based on user input 210 related to the addresses, verification rules 212 applied to user input 210, similarities 216 among the addresses, and/or location types 218 of the addresses, the system of FIG. 2 may standardize the verification of large amounts of location data from a variety of unverified address sources 232. Moreover, sourcing the addresses from different unverified address sources 232 may increase the likelihood that a valid address is found for a given entity. Subsequent confirmation of the location data may further be tailored to the assigned confidence 214 levels, thereby streamlining confirmation of high-confidence addresses while requiring manual verification and/or confirmation of medium-confidence and low-confidence addresses. Consequently, such large-scale, end-to-end sourcing, verification, and confirmation of addresses may improve the operation and use of location-based services and technologies, as well as applications and computer systems in which the services and technologies execute.

Those skilled in the art will appreciate that the system of FIG. 2 may be implemented in a variety of ways. First, identification apparatus 202, verification apparatus 204, confirmation apparatus 206, unverified address repository 234, and/or suggested address repository 236 may be provided by a single physical machine, multiple computer systems, one or more virtual machines, a grid, one or more databases, one or more filesystems, and/or a cloud computing system. Identification apparatus 202, verification apparatus 204, and/or confirmation apparatus 206 may additionally be implemented together and/or separately by one or more hardware and/or software components and/or layers. Moreover, various components of the system may be configured to execute in an offline, online, and/or nearline basis to perform different types of processing related to aggregating, storing, verifying, and/or confirming addresses.

Second, the operation of identification apparatus 202, verification apparatus 204, and/or confirmation apparatus 206 may be adjusted to perform different types of verification of location data for entities 228. For example, verification rules 212 may be customized and/or configured to assign more or fewer levels of confidence 214 to addresses from unverified address repository 234 based on different types or amounts of user input 210, similarities 216, location types 218, and/or other parameters. In turn, confirmation of the addresses may be customized to ensure a certain level of validity or accuracy for each level of confidence 214. In another example, additional external services 208 (e.g., address-verification tools, text-processing tools, etc.) may be used to perform different types of processing, cleanup, validation, and/or comparison of addresses in unverified address repository 234.

Finally, addresses that are aggregated, verified, and/or confirmed using the system may be used with a variety of location-based services. For example, verified and/or confirmed addresses may be used to exchange correspondence with the entities, calculate shipping or transport costs to or from the entities, and/or perform location-based matching or recommendation of the entities to potential customers, clients, students, mentors, mentees, and/or other roles.

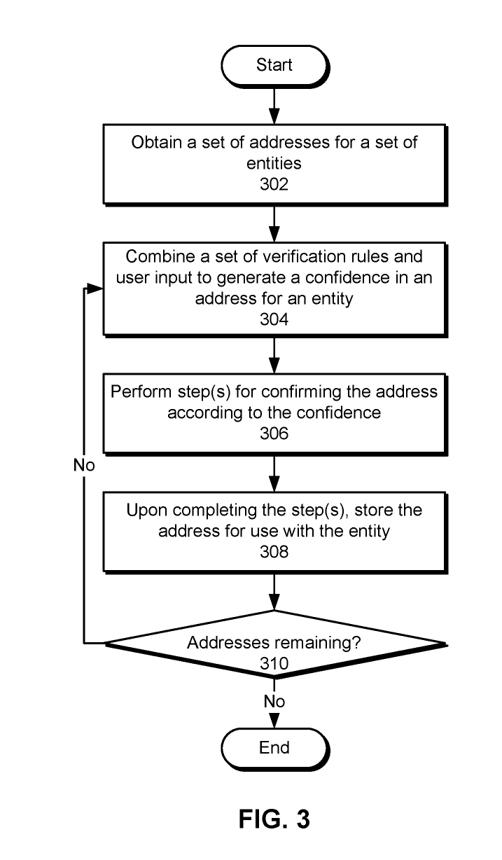

FIG. 3 shows a flowchart illustrating a process of verifying a set of addresses for a set of entities in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a set of addresses for a set of entities is obtained (operation 302). The entities may be identified as having higher priority than other entities in a larger set of entities. For example, the entities may be associated with higher popularity, reputation, prominence, and/or importance than other entities in a given system (e.g., social network, website, database, etc.). The addresses for the entities may then be aggregated from a number of unverified address sources, such as public records, crowdsourcing platforms, CRM platforms, unverified users associated with the entities, and/or websites.

Next, a set of verification rules and user input is combined to generate a confidence in an address for an entity (operation 304) in the set of entities. The user input may include addresses from the unverified sources and/or addresses from job listings, company pages, company administrators, and/or other verified sources. The verification rules may include one or more thresholds that are applied to the user input to determine the confidence in the address as high, medium, or low. The confidence may further be assigned based on merging of the address with a similar address and/or validating a location type of the address.

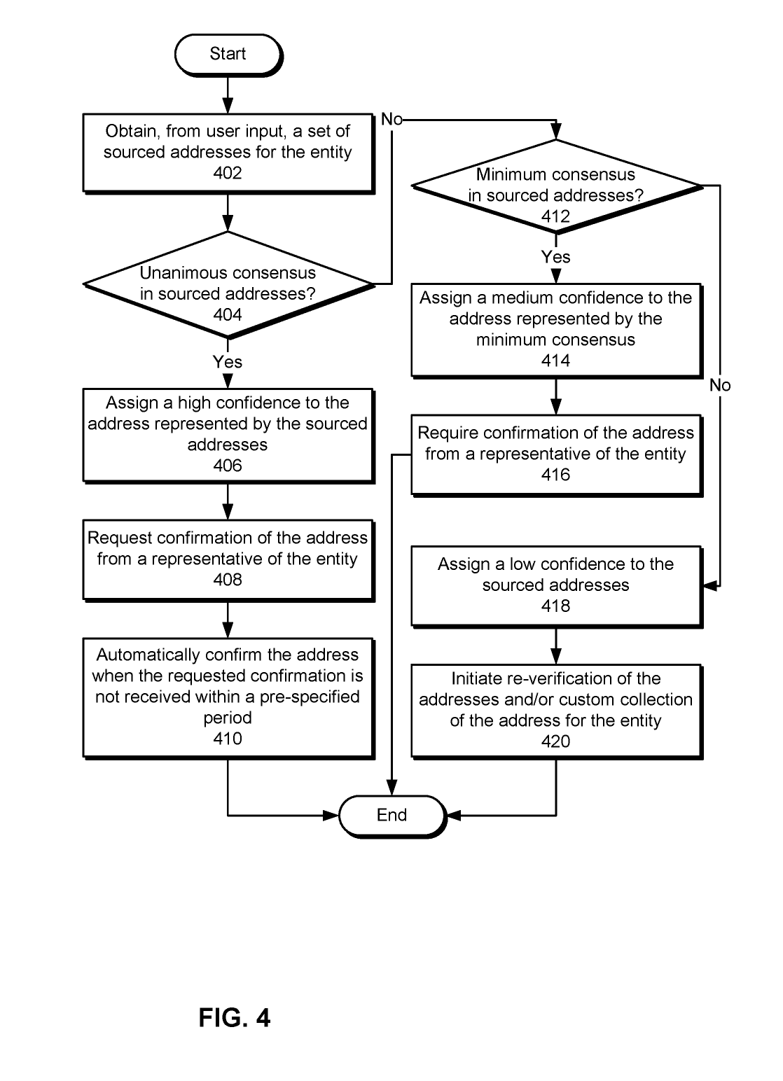

One or more steps for confirming the address according to the confidence are performed (operation 306). For example, an unverified address sourced from a crowdsourcing platform may be confirmed based on the level of confidence assigned to the address, as described in further detail below with respect to FIG. 4. In another example, addresses from verified sources may be automatically confirmed.

Upon completing the step(s) for confirming the address, the address is stored for use with the entity (operation 308). For example, the address may be stored with a company-city pair representing the entity. The address may then be included in a job listing and/or company page for the entity, used to determine a commute time for a job candidate, and/or provide other location-based information or services associated with the entity.

Operations 304-308 may be repeated for remaining addresses (operation 310) obtained in operation 302. In turn, a subset of addresses obtained in operation 302 may be confirmed as valid addresses for the corresponding entities and used with the entities.

FIG. 4 shows a flowchart illustrating a process of verifying and confirming an address for an entity in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

First, a set of sourced addresses for an entity is obtained (operation 402). For example, the sourced addresses may be obtained from a crowdsourcing platform, users of an online professional network, and/or other users that are not official representatives of the entity. Next, a threshold for unanimous consensus in the sourced addresses (operation 404) is applied. For example, the threshold may be met if all of the sourced addresses are identical or represent the same physical address or location. The threshold may further include a minimum number of sourced addresses with the unanimous consensus.

If unanimous consensus is found in the sourced addresses, a high confidence is assigned to the single address represented by the sourced addresses (operation 406), and confirmation of the address is requested from a representative of the entity (operation 408). The address is then automatically confirmed when the requested confirmation is not received within a pre-specified period (operation 410). The address may alternatively be confirmed when the requested confirmation is received within the pre-specified period. If the address is rejected by the representative, the address may be removed as a valid address for the entity, and an alternative address may be obtained from the representative and/or another source.

If unanimous consensus is not found in the sourced addresses, a second threshold for a minimum consensus in the sourced addresses (operation 412) is applied. For example, the minimum consensus may include a minimum number or percentage of identical or substantially identical sourced addresses. If the second threshold is met, a medium confidence is assigned to the address represented by the minimum consensus (operation 414), and confirmation of the address from a representative of the entity is required (operation 416) before the address can be used with the entity. If the confirmation is not received, the address remains unverified. The address may then be removed from consideration for the entity after a pre-specified period.

If the minimum consensus is not found in any of the sourced addresses, a low confidence is assigned to the sourced addresses (operation 418), and re-verification of the sourced addresses and/or custom collection of the address for the entity is initiated (operation 420). For example, the low-confidence addresses may be fed back into the crowdsourcing platform and/or displayed to users that are officially or unofficially associated with the entity. In another example, an agent or operator may use phone calls, web searches, and/or other methods to manually collect the address. Any addresses generated or updated in operation 420 may then be assigned a new set of confidence levels, verified, and/or confirmed using operations 404-420. Conversely, addresses that remain at low confidence after a pre-specified period (e.g., 14 days, a certain number of rounds of crowdsourcing or verification, etc.) may be removed from consideration for the entity.

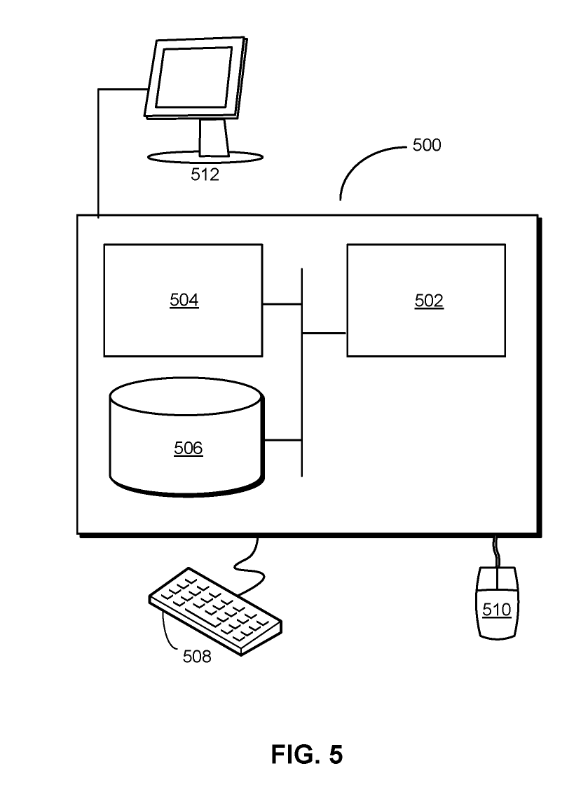

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes a verification apparatus and a confirmation apparatus, one or more of which may alternatively be termed or implemented as a module, mechanism, or other type of system component. The verification apparatus obtains a set of addresses for a set of entities. Next, for each address in the set of addresses, the verification apparatus combines a set of verification rules and user input to generate a confidence in the address for a corresponding entity. The confirmation apparatus then performs one or more steps for confirming the address according to the confidence in the address. Upon completing the step(s) for confirming the address, the confirmation apparatus stores the address for use with the corresponding entity.

In addition, one or more components of computer system 500 may be remotely located and connected to the other components over a network. Portions of the present embodiments (e.g., identification apparatus, verification apparatus, confirmation apparatus, unverified address repository, suggested address repository, etc.) may also be located on different nodes of a distributed system that implements the embodiments. For example, the present embodiments may be implemented using a cloud computing system that aggregates, verifies, and confirms address and/or location data for a set of remote entities.

By configuring privacy controls or settings as they desire, members of a social network, an online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings, and is in compliance with applicable privacy laws of the jurisdictions in which the members or users reside.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of addresses for a set of entities;
for each address in the set of addresses, combining, by one or more computer systems, a set of verification rules and user input to generate a confidence in the address for a corresponding entity;
performing, by the one or more computer systems, one or more steps for confirming the address according to the confidence in the address; and
upon completing the one or more steps for confirming the address, storing the address for use with the corresponding entity.

2. The method of claim 1, wherein obtaining the set of addresses for the set of entities comprises:
identifying, from a larger set of entities, the set of entities as having a higher priority than other entities in the larger set of entities; and
aggregating the set of addresses from a set of unverified address sources.

3. The method of claim 2, wherein the set of unverified address sources comprises at least one of:
a public record;
a crowdsourcing platform;
a customer-relationship-management (CRM) platform;
an unverified user; and
a website.

4. The method of claim 1, wherein obtaining the set of addresses for the set of entities comprises:
obtaining a subset of the addresses from job listings for a subset of the entities.

5. The method of claim 4, wherein applying the set of verification rules and the user input to generate the confidence in the address comprises:
assigning a high confidence to the subset of the addresses from the job listings.

6. The method of claim 1, wherein applying the set of verification rules and the user input to generate the confidence in the address for the corresponding entity comprises:
obtaining, from the user input, a set of sourced addresses for the corresponding entity;
applying one or more thresholds from the set of verification rules to the sourced addresses to determine a high confidence, medium confidence, or low confidence in the address for the corresponding entity.

7. The method of claim 6, wherein the one or more thresholds comprises:
a high-confidence threshold comprising a minimum number of the sourced addresses and a unanimous consensus in the sourced addresses.

8. The method of claim 6, wherein the one or more thresholds comprises:
a medium-confidence threshold comprising a minimum consensus in the sourced addresses for the corresponding entity.

9. The method of claim 6, wherein performing the one or more steps for confirming the address according to the confidence in the address comprises:
after the high confidence in the address is determined, requesting confirmation of the address from a representative of the entity; and
automatically confirming the address when the requested confirmation is not received within a pre-specified period.

10. The method of claim 6, wherein performing the one or more steps for confirming the address according to the confidence in the address comprises:
after the medium confidence in the address is determined, requiring confirmation of the address from a representative of the entity.

11. The method of claim 1, wherein applying the set of verification rules and the user input to generate the confidence in the address for the corresponding entity comprises at least one of:
merging the address with a similar address; and
validating a location type of the address.

12. The method of claim 1, wherein use of the address with the corresponding entity comprises at least one of:
including the address in one or more job listings for the corresponding entity;
including the address in a company listing for the corresponding entity; and
determining a commute time for a job candidate to the address.

13. The method of claim 1, wherein the set of entities comprises a company-city pair.

14. A system, comprising:
one or more processors; and
memory storing instructions that, when executed by the one or more processors, cause the system to:
obtain a set of addresses for a set of entities;
for each address in the set of addresses, combine a set of verification rules and user input to generate a confidence in the address for a corresponding entity;
perform one or more steps for confirming the address according to the confidence in the address; and
upon completing the one or more steps for confirming the address, store the address for use with the corresponding entity.

15. The system of claim 14, wherein applying the set of verification rules and the user input to generate the confidence in the address for the corresponding entity comprises:
obtaining, from the user input, a set of sourced addresses for the corresponding entity;
applying one or more thresholds from the set of verification rules to the sourced addresses to determine a high confidence, medium confidence, or low confidence in the address for the corresponding entity.

16. The system of claim 15, wherein the one or more thresholds comprises:
a high-confidence threshold comprising a minimum number of the sourced addresses and a unanimous consensus in the sourced addresses

17. The system of claim 15, wherein the one or more thresholds comprises:
a medium-confidence threshold comprising a minimum consensus in the sourced addresses for the corresponding entity.

18. The system of claim 15, wherein performing the one or more steps for confirming the address according to the confidence in the address comprises:
after the high confidence in the address is determined, requesting confirmation of the address from a representative of the entity; and
automatically confirming the address when the requested confirmation is not received within a pre-specified period.

19. The system of claim 15, wherein performing the one or more steps for confirming the address according to the confidence in the address comprises:
after the medium confidence in the address is determined, requiring confirmation of the address from a representative of the entity.

20. A non-transitory computer-readable storage medium storing instructions that when executed by a computer cause the computer to perform a method, the method comprising:
obtaining a set of addresses for a set of entities;
for each address in the set of addresses, combining a set of verification rules and user input to generate a confidence in the address for a corresponding entity;
performing one or more steps for confirming the address according to the confidence in the address; and
upon completing the one or more steps for confirming the address, storing the address for use with the corresponding entity.
